(19) United States
(12) Patent Application Publication
(10) Pub. No.: US 2020/0043345 A1
(43) Pub. Date: Feb. 6, 2020

(54) LIGHTING CONTROL

(71) Applicant: SIGNIFY HOLDING B.V., EINDHOVEN (NL)

(72) Inventors: Dominika LEKSE, EINDHOVEN (NL); Judith Hendrika Maria DE VRIES, EINDHOVEN (NL); Ralf Gertruda Hubertus VONCKEN, EINDHOVEN (NL); Alexandre Georgievich SINITSYN, EINDHOVEN (NL); Tom VERHOEVEN, EINDHOVEN (NL)

(21) Appl. No.: 16/341,259

(22) PCT Filed: Oct. 11, 2017
(86) PCT No.: PCT/EP2017/075954

§ 371 Date: Apr. 11, 2019

(30) Foreign Application Priority Data
Oct. 18, 2016 (EP) 16194291.7

(51) Int. Cl. G08G 1/00; G08G 1/09; G01C 21/20; G06Q 10/06; H05B 37/02

(52) U.S. Cl. CPC G08G 1/202; G08G 1/09; H05B 37/0227; G06Q 10/06311; G01C 21/20

(57) ABSTRACT

A controller (160) for controlling a lighting system so as to guide a vehicle, comprising: an interface (166) arranged for communicating with at least one luminaire (116, 126, 136) for illuminating an environment in which at least one container (112, 122, 132) is located, the interface (166) further arranged to communicate with at least one sensor (114, 124, 134) for monitoring usage of the at least one container, the controller (160) arranged to receive and process information of the at least one container from the at least one sensor (114, 124, 134), so as to obtain status information of the at least one container (112, 122, 132); and the controller (160) arranged to receive positioning information from a vehicle (140) in the environment; the controller (160) arranged to use the status information of the at least one container and the positioning information of the vehicle (140) to cause the at least one luminaire (116, 126, 136) to be illuminated in a fashion that guides a driver of the vehicle relative to the at least one container (112, 122, 132).

### FIELD OF THE INVENTION

The present invention relates to the control of a lighting system. More particularly the present invention relates to control of a lighting system in order to provide guidance.

### BACKGROUND OF THE INVENTION

Lighting systems often provide static or functional lighting. For example in public spaces such as an airport, train station, or city center, public lighting systems tend to either have the lights switched on (e.g. at night), or switched off (e.g. during the day). With the introduction of LED lighting the use of interactive lighting is emerging, for example for creating ambient illumination.

Public services, such as garbage or refuse collection, often operate during the night or early in the morning when traffic conditions are favorable. At such times the environment is typically dark so street lighting is used to provide visibility of targets, such as trash cans. Time is often wasted as empty or nearly empty bins are processed. Furthermore, although many garbage trucks are fitted with a global positioning system (GPS) for navigation, the accuracy of the GPS system is such that it may not be able to pin-point particular bins or be able to discriminate between bins.

### SUMMARY OF INVENTION

According to a first aspect there is provided a controller for controlling a lighting system so as to guide a vehicle, comprising: an interface arranged for communicating with at least one luminaire for illuminating an environment in which at least one container is located, the interface further arranged to communicate with at least one sensor for monitoring usage of the at least one container, the controller arranged to receive and process information of the at least one container from the at least one sensor, so as to obtain status information of the at least one container; and the controller arranged to receive positioning information from a vehicle in the environment; the controller arranged to use the status information of the at least one container and the positioning information of the vehicle to cause the at least one luminaire to be illuminated in a fashion that guides a driver of the vehicle relative to the at least one container.

There is also provided a lighting system for guiding a vehicle, the system comprising: at least one luminaire for illuminating an environment in which at least one container is located; at least one sensor for monitoring usage of the at least one container; a controller communicatively connected to the at least one sensor and the at least one luminaire for communication therewith; the controller arranged to receive and process information of the at least one container from the at least one sensor, so as to obtain status information of the at least one container; and the controller arranged to receive positioning information from a vehicle in the environment; the controller arranged to use the status information of the at least one container and the positioning information of the vehicle to cause the at least one luminaire to be illuminated in a fashion that guides a driver of the vehicle relative to the at least one container.

Therefore a controller and system are provided which can illuminate luminaires, such as street lamps, in a manner that provides guidance to a driver of a vehicle.

The illuminating the at least one luminaire in a fashion that guides a driver of the vehicle relative to the at least one container may comprise a change of state of the at least one luminaire. For example it may comprise a change from an “off” state to an “on” state. Alternatively it may comprise a change of state from a relatively dim state to a relatively bright state, and vice versa.

In some embodiments the at least one container comprises a plurality of containers. In some embodiments the at least one luminaire comprises a plurality of luminaires. In some embodiments the at least one sensor comprises a plurality of sensors.

In some embodiments the luminaire(s) and container(s) are provided on a one to one basis i.e. each luminaire is configured to illuminate a respective container. In other embodiments a luminaire may be configured to illuminate more than one container. Where a luminaire is configured to illuminate more than one container, the controller may be arranged to control that luminaire in a fashion such that it can illuminate different containers differently. For example a luminaire may comprise an array of LEDs. In such a case the LEDs can be selectively fired in a fashion which illuminates separate containers differently.

The at least one container can include any form of container or receptacle which is configured to receive items placed therein, and accordingly will require emptying at some point. The at least one container can be of any size or style. According to some embodiments, the at least one container comprises at least one garbage container, which may also be referred to as a garbage bin, rubbish bin, trash can etc. These can be any kind of garbage containers, be that mixed garbage, recycling etc. In another embodiment the at least one container may comprise a post-box for receiving letters, parcels etc.

The positioning information of the vehicle can be obtained directly from the vehicle, or from a server serving the vehicle. For example the positioning information may be obtained from a GPS on the vehicle.

The GPS on the vehicle and the lighting system can work in tandem to provide improved guidance for the driver of the vehicle. For example the GPS system can be used to provide higher level guidance, such as guiding a driver to a street or parking lot in which one or more containers to be emptied are located. The lighting system can provide a finer granularity of guidance and guide the driver to a particular container or containers to be emptied, once the vehicle is on the street or parking lot in question. In some embodiments the GPS system provides the driver with audio guidance instructions. This means that the driver does not have to take his eyes off the road when being guided by the GPS system and the lighting system.

The vehicle can be any kind of vehicle, of any size or style. Where the container(s) are garbage containers, the vehicle may comprise a garbage truck. Where the container(s) comprise post-boxes the vehicle may comprise a postal van, truck, motorcycle or bicycle etc.

According to some embodiments the status information comprises a fill-level of the at least one container. The “fill-level” is an indication of how full the container is. The fill-level may be continuously or regularly communicated to the controller, for example giving updates as the container fills up. Alternatively the fill-level may be communicated to the controller only once a threshold fill-level has been met/triggered. According to some embodiments the status information may comprise a first status indicative of a bin that needs emptying, or a second status indicative of whether a bin does not need emptying.

According to some embodiments, the status information comprises information of walking patterns of people. This enables a determination to be made of how busy an area is and therefore how likely it is that the containers will need emptying. This information can also be stored so that the controller can learn patterns. For example the controller can learn that “area A” is busy on Saturdays and therefore typically the bins will need emptying on Saturday evenings or Sunday mornings.

According to some embodiments the controller is arranged to communicate with at least one sensor, which at least one sensor is monitoring the usage of the at least one container. The at least one sensor may comprise any combination of: one or more cameras; one or more microphones; one or more infra-red cameras; one or more external data sources of container usage. Where a camera or cameras are used the footage may be analyzed and processed to determine usage of one or more containers. Where a microphone or microphones are used then the sounds received may be analyzed and processed to determine usage of one or more of the containers. Where an infra-red camera is used, this may obtain temperature information of a container or containers, which temperature information can be processed to determine usage of a container or containers. A motion sensor may also be used to determine motion indicative of use of the container. This could be motion of people in the area to indicate how busy the area is, or motion of the container itself such as motion of a lid of the container opening and closing. In some embodiments the at least one sensor comprises a switch. The switch may be triggered for example when the fill-level of a container reaches a certain level. In some embodiments the at least one sensor comprises a weighing scales. Using the weighing scales the weight of the container can be used to determine how full the container is. Where external data sources are used, this may comprise by way of example tracking smart devices (e.g. smart phones) to monitor movement linked to an activity of throwing away trash. A specific movement in an area may be linked to using the container. Or a camera of the smart device (smart phone or smart glasses) may be used.

According to some embodiments the controller is arranged to communicate with at least one sensor attached to the at least one container. The sensor may be mounted internally or externally to the container. It may therefore be considered that the sensor is embedded in a container.

In some embodiments the at least one sensor is external to and remote from a container which it is monitoring. For example the sensor may be attached to its own fitting which is spaced from the container. In some embodiments at least one sensor which is monitoring a container is mounted to a fixture on which the at least one luminaire which is arranged to illuminate that container is also mounted. For example the sensor may be mounted on a street lamp fitting. Therefore in some embodiments it may be considered that the controller is arranged to communicate with at least one sensor which monitors one or more containers remotely.

According to some embodiments the controller is configured to cause the at least one luminaire to be illuminated in a directional manner. For example the illumination may point in a direction towards a container that needs to be emptied. Together, a plurality of luminaires may provide directional lighting. For example a series of luminaires may be illuminated in a progressively more intense manner towards a container that needs emptying, or flash in turn towards a container that needs emptying.

According to some embodiments the controller is configured to cause the at least one luminaire to illuminate the at least one container with an intensity dependent on its need for emptying. For example, a container which needs emptying is caused to be illuminated with light of an intensity which is greater than an intensity of illumination of a container that does not need emptying, or has less of a need for emptying. Such intensity of illumination can be provided based upon a degree of need for emptying. For example a range of intensities may be possible which vary based upon how full a container is. In some embodiments, such variations of illumination can be carried out in real time as a container becomes more or less full. Alternatively there may be fewer, fixed illumination states available. For example a first, relatively bright state indicates that a bin needs emptying and a second, relatively dim state indicates that a bin does not need emptying.

According to some embodiments the controller is arranged to cause the illumination of the at least one luminaire so as to guide the driver of the vehicle dependent upon a detected distance of the vehicle from the at least one luminaire. For example the luminaire will only illuminate in a manner so as to provide the guiding function when the vehicle comes within a certain proximity of that luminaire or its respective container. This proximity can be a predetermined distance, for example 250 meters. Of course other distances may be used. The distance may be a radial distance from a respective container, or a distance of travel. This means that other road or public space users are not distracted by the illumination or manner of illumination when the vehicle (e.g. garbage truck) is not within proximity of the container to be emptied and it respective luminaire. Similarly the controller may be arranged to cause the illumination of the at least one luminaire so as to guide the driver of the vehicle dependent upon a time it is determined that the vehicle will take to reach the container. For example, the illumination of the luminaire in a manner to provide guidance may be caused to occur when it is determined that the vehicle is 1 minute away from the container. Of course any other pre-set time may be used.

According to some embodiments the controller is further configured to calculate a route which minimizes resource usage of the vehicle and/or driver, the controller configured to illuminate the at least one luminaire in accordance with the calculated route. For example the controller can calculate a route which minimizes time and/or fuel consumption, and control the lighting system and/or the positioning system of the vehicle accordingly.

According to a further embodiment there is provided a method of guiding a vehicle comprising: receiving information from at least one sensor, the information comprising status information of at least one container in an environment in which the at least one container is located; receiving positioning information from a vehicle in the environment; and using the status information of the at least one container and the positioning information of the vehicle to cause the at least one luminaire to be illuminated in a fashion that guides a driver of the vehicle relative to the at least one container.

In a further aspect there is provided a computer program product comprising computer-executable code embodied on a non-transitory storage medium arranged so as when executed on one or more processing units to carry out the method steps of the previous aspect.

### BRIEF DESCRIPTION OF DRAWINGS

Embodiments will be further described with respect to the Figures in which:

FIG. 1 schematically shows a system according to an embodiment;

FIG. 2 schematically shows illumination of a garbage bin by a luminaire, according to an embodiment;

FIG. 3 schematically shows a lighting system guiding a driver of a vehicle towards a garbage bin to be emptied, according to an embodiment;

FIG. 4 is a flowchart showing a method according to an embodiment.

### DETAILED DESCRIPTION

Some embodiments will now be described in more detail to help in understanding the invention. Whilst the embodiments predominantly describe luminaires for illuminating garbage bins, and a garbage truck for collecting garbage from those garbage bins, it will of course be understood that this is by way of example only and that the container or containers could be any kind of containers that need emptying periodically or from time to time, and that the vehicle can be any kind of vehicle suitable for the purpose of guiding a driver to those containers.

Public services such as garbage collection or postal collection often take place during the night or early in the morning so as to avoid times of heavy traffic. The illumination of collection points, for example a garbage container or a post-box, is often provided by street lighting. Typically street lighting operates according to a fixed routine, for example the lighting will turn on at 7 pm and will turn off at 7 am so that lighting is provided during times of low or no natural light. Street lights may also be provided with light sensors so that they can automatically determine when the natural light is at a level such that it needs augmenting with artificial light.

Municipal service drivers, for example the drivers of garbage trucks, may follow set routes for bin collections. The drivers may learn these routes and then follow the routes from memory. Garbage trucks may be fitted with a positioning system such as GPS satellite navigation which enables the driver to follow navigation instructions. GPS can be useful in order to direct a driver to the general vicinity of a garbage bin, but it may not be accurate enough to direct a driver to a specific bin. For example GPS may be sufficiently accurate to direct a driver to a particular street or parking lot in which a bin is located, but the GPS may not be accurate enough to direct a driver to a bin on that street or parking lot, or be able to positionally discriminate between bins in that area. Furthermore, a GPS system cannot provide any information as to whether a garbage bin needs emptying. This means that time and resources may be wasted in travelling to bins that do not need emptying. Accordingly drivers may end up driving in an inefficient manner in order to complete their round. This can lead to a waste of resources such as fuel, as well as wasting time and potentially causing unnecessary traffic congestion on the roads.

Embodiments of the present invention provide dynamic control of a lighting system and, in conjunction with positional information received from a vehicle, can control the lighting system in order to provide more detailed positional information regarding one or more containers that may or may not need emptying, in order to efficiently direct a driver of a vehicle.

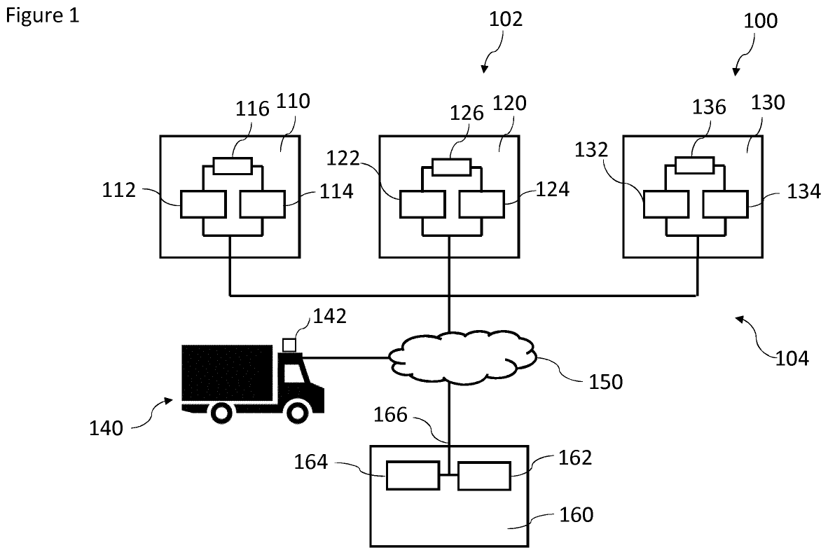

FIG. 1 schematically shows a system 100 according to an embodiment. In this embodiment there are shown three geographical areas 110, 120 and 130. This is by way of example only and of course more or fewer geographical areas may be provided. The number of “geographical areas” is of course to some extent notional. That is a large geographical area may be considered as a single area, or may alternatively be considered as comprising a number of constituent areas. Nevertheless it will be understood that the system is able to cope with a plurality of geographical areas, for example a number of districts within a city.

The first geographical area 110 comprises at least one garbage bin 112 and at least one sensor 114 for monitoring the at least one garbage bin 112. Likewise the second geographical area 120 comprises at least one garbage bin 122 and at least one sensor 124 for monitoring the at least one garbage bin 122. The third geographical area 130 comprises at least one garbage bin 132 and at least one sensor 134 for monitoring the at least one garbage bin 132. Of course, an embodiment is also encompassed where there is a single container in the system. The invention is not limited to any particular ratio of container(s) to luminaire(s) to sensor(s).

A garbage truck is shown at 140. On its rounds the garbage truck 140 may visit one or more of the locations 110, 120 and 130 to collect garbage from one or more of garbage bins 112, 122, 132. The garbage truck 140 is fitted with a positioning system 142 and/or tracker. Using the positioning system 142 and/or tracker the garbage truck 140 can receive information regarding its location, and the garbage truck 140 can also transmit information regarding its location.

Each location further comprises at least one luminaire for illuminating an area proximate to a respective garbage bin, for example the luminaires may be arranged to illuminate a roadway, pavement, parking lot etc., or one or more of the luminaires may be used to directly illuminate one or more respective garbage bins. To this end the first location 110 comprises at least one luminaire 116, the second location 120 comprises at least one luminaire 126, and the third location 130 comprises at least one luminaire 136. The luminaires 116, 126 and 136 may be considered to be part of a lighting system generally designated 102. Together, the garbage bins, sensors and luminaires may be considered to form part of a lighting and sensing system generally designated 104.

A controller is shown at 160. The controller 160 is communicatively connected to lighting and sensing system 104 as well as garbage truck 140. This connection may be a wireless connection such as Wi-Fi, or any current or future communication technology such as 3G, 4G or 5G, or any kind of internet connection. In this example the connection is a wireless internet connection shown generally at 150.

The controller 160 comprises a memory 162 and a processor 164. Together, the processor and memory can process and store received information via an interface 166. Also, the controller 160 can transmit information and/or instructions via the interface 166. For example, the controller 160 can receive and process information from the garbage truck 140 of its location. Likewise, the controller 160 can transmit information to the garbage truck 140, such as directional or guidance information. The controller 160 can also receive information from the sensing and lighting system 104, and can also send instructions to the lighting and sensing system 104. For example, the controller 160 may receive information from one or more of sensors 114, 124 and 134 of a usage of one or more of garbage bins 112, 122 and 132. The controller 160 can then use this information to determine which garbage bins need emptying. The controller 160 can also control the illumination of luminaires 116, 126 and 136. For example the controller can cause the luminaires to turn on or off, or to illuminate in a certain fashion such as varying intensity, or flashing or strobing etc.

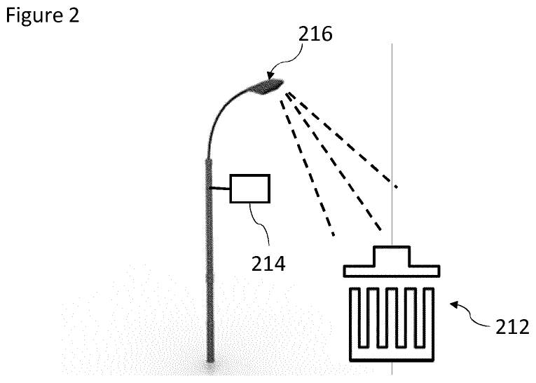

FIG. 2 is a simplified example showing a luminaire 216 illuminating a garbage container 212. A sensor is shown at 214. In this example the luminaire 216 comprises a street lamp. The luminaire 216 may comprise any means for lighting. For example the luminaire 216 may comprise a bulb or lamp such as a high-intensity discharge (HID) lamp. Alternatively the luminaire 216 may comprise one or more LEDs. Where LEDs are used these may be smart LEDs. The luminaire 216 can provide a number of illumination states. For example the luminaire can be fully off or fully on. The luminaire can also provide illumination of any intensity between a fully off and a fully on state. For example the luminaire may be able to provide low level, ambient lighting, or alternatively the luminaire can provide fully on and bright lighting in order to provide maximum illumination. The luminaire can, in some embodiments, provide light in different directions so that light can be provided on two separate containers if needed. In some embodiments the luminaire can also provide different patterns of light, if required.

A sensor 214 is provided for sensing usage of the garbage bin 212. The sensor 214 is shown as connected to a fitting (e.g. lamp post) of the luminaire 216. In alternative embodiments the sensor 214 is attached to or contained within the garbage container 212. Alternatively the sensor 214 may be comprised externally from the luminaire 216 and garbage container 212. Nevertheless, whichever way the sensor 214 is mounted it is able to sense usage of the garbage container 212, and is able to feed this information back to controller 160.

The sensor 214 can take any form. For example the sensor 214 may be a camera, a microphone, a motion detector, or any combination thereof. Where the sensor is a camera, it may comprise an infrared camera.

In some embodiments monitoring usage of the container 212 may comprise monitoring a fill level of the container i.e. how full the container is. For example the camera may monitor how often rubbish is put into the bin. The camera may also monitor the size of items of rubbish that are put into the bin. The sensor may simply forward on this information to the controller 160. For example the sensor may forward this information in a “dumb” fashion. Alternatively the sensor 214 may also have its own memory and processing functionality, enabling the sensor 214 to determine a fill level of the container 212. The sensor can then forward more detailed information on to the controller such as a message indicating a fill level of the container. To this extent it may be considered that the processing and storing of information may be distributed throughout the system.

Where the sensor comprises a microphone, the microphone can pick up sound signals of the sound of rubbish being placed in the bin. This information can then be used to estimate a fill level of the bin.

Where an infrared camera is used, this can monitor a fill level of the garbage bin based upon temperature variations within the bin.

In embodiments where the sensor 214 is located on or in the garbage container 212, then the sensor can take a fairly simple form. For example the sensor 214 could be a temperature sensor. Alternatively the sensor 214 could be a switch or could be in communication with a switch which is operated every time a lid or door of the garbage bin is opened and closed.

The sensor 214 may also monitor usage of the garbage container 212 indirectly. For example the sensor 214 may monitor how busy a location is, for example by monitoring a number of people walking in the vicinity of or past the container. Using this information a likely usage of the container can be ascertained, either by the controller 160 or by the sensor 214 performing the processing and informing the controller 160.

The sensor may be located remotely from a transmitter which transmits the sensed information to the controller. For example, the sensor may be located on the bin and the transmitter may be comprised in a module remote from the bin, for example the module may be located on a lamp post. The sensor and module can communicate information with each other in any way, such as using light signals or radio frequency (RF) signals.

In some embodiments the container comprises a sensor (e.g. a fill-level sensor) which can send out an RF signal. The luminaire may also have a sensor, which may for example receive the RF signal, enabling the container and luminaire to communicate information. This information can be stored at the luminaire and/or forwarded on to the controller.

In the example of FIG. 2 there is shown a single luminaire 216, a single sensor 214 and a single garbage container 212. It will of course be understood that this is by way of example for ease of explanation (although this embodiment is also encompassed), and that the invention may be brought into effect by using different ratios of luminaires, sensors and containers. For example a single luminaire can illuminate more than one container. A single luminaire may be able to illuminate two separate containers in a separate fashion. For example where a luminaire comprises an array of LEDs, then those LEDs can be lit in a fashion to light one container more brightly than another container. Likewise a single sensor 214 may be able to monitor more than one container. For example a sensor 214 can simultaneously monitor more than one container, but still feedback information to the controller regarding individual containers.

In some embodiments the proximity of a container to one or more luminaires, and its position relative to the luminaire determines, or at least partially determines, the light pattern output by the luminaire in order to illuminate that container. For example if the container is close to the luminaire then a less intense light beam may be required to illuminate the container than if the container is relatively far away from the luminaire. Also, if a container is positioned diagonally across from the luminaire then a different illumination pattern may be required than if the container is directly below the luminaire. The pattern and/or intensity of light can also be adjusted dependent on the weather conditions. This may involve calculating/determining (for example by the controller) what light level is really needed dependent on the environment. Light sensors may be used to provide this information to the controller. Where the luminaire comprises an array of LEDs then adjusting the pattern of light may involve selectively firing different LEDs in the array, or firing different LEDs with different intensities.

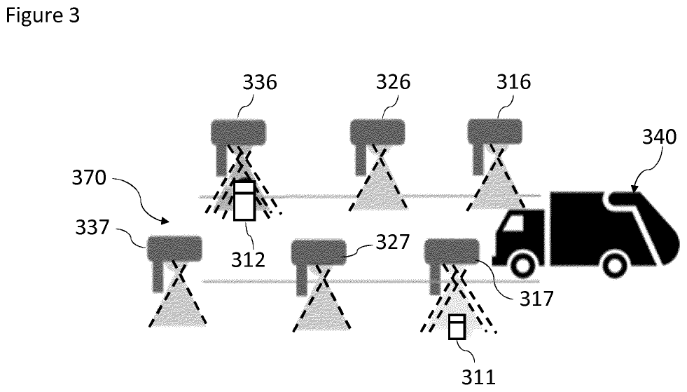

Using information from the sensors, the controller 160 can cause the luminaires to be lit or illuminated in a fashion which guides a driver of the garbage truck to one or more containers to be emptied. This can occur in conjunction with use of GPS in the garbage truck for navigation. Therefore to some extent it can be considered that the GPS system provides high-level guidance (e.g. guiding the driver to a particular street or parking lot), whereas the lighting system can be used to provide finer and or more granular guidance, such as to a particular container to be emptied. This is explained in more detail with respect to FIG. 3.

FIG. 3 shows a garbage truck 340 driving on a roadway 370. By the side of the roadway 370 are located luminaires 316, 317, 326, 327, 336 and 337. A driver of the garbage truck 340 has been guided to roadway 370 by an on-board GPS system in the garbage truck. The luminaires 316 to 337 provide general illumination of the roadway and/or a kerb on the side of the roadway. An intensity of illumination provided by the luminaires is schematically shown by the dashed lines emanating from respective luminaires. For example relatively few dashed lines represents light of low intensity or brightness, whereas relatively more dashed lines shows illumination of a higher intensity or brightness. A first garbage bin is shown at 311 and a second garbage bin is shown as 312. In this example the garbage bin 311 does not need emptying, whereas garbage bin 312 needs emptying. In other words garbage bin 312 has a greater need of emptying than garbage bin 311. Therefore the garbage bin 312 is illuminated with a higher intensity level of illumination than the garbage bin 311. In some embodiments a luminaire will illuminate a garbage container with differing (e.g. higher) intensity only when that garbage container reaches a point that it needs emptying, rather than, for example, based on relative fullness compared to other garbage containers (although such embodiments are also encompassed). In this example the luminaires which do not have associated containers (e.g. luminaires 316, 326, 327 and 337) provide illumination at an intensity level that is lower than luminaires 336 and 317. Of course, other embodiments are encompassed whereby bins that need emptying are illuminated with an intensity that is lower than bins which do not need emptying or have less need for emptying. Whichever way is carried out, the point is that illumination intensity can be used to distinguish a fill level or need for emptying of containers. In some embodiments lighting styles other than intensity can be used for distinguishing between containers based on fill-level. For example flashing or strobing effects may be used.

In some embodiments a lighting condition of a luminaire indicating that a container needs to be emptied may remain as long as at least one container needs to be emptied. For example if there are two containers triggering the illumination effect on a luminaire, then when one of the containers is emptied the light effect may remain on to indicate that the other container also needs emptying. In some embodiments a luminaire is not dimmed immediately after a respective illuminated garbage container has been emptied, so that passing drivers are not disturbed. In some embodiments the dimming of the light is carried out gradually or very gradually. Likewise, where a status of a bin is changed to an “emptying required” status, the change of intensity of an associated luminaire may also be carried out gradually so as not to startle drivers or passers-by. If garbage containers are located next to or close to each other, then there may be limited optimization to be had if both are emptied. If on the other hand the distance between the two containers is more than a threshold distance, say “x” meters, then the light may be able to create a pattern to be able to shine on both individually.

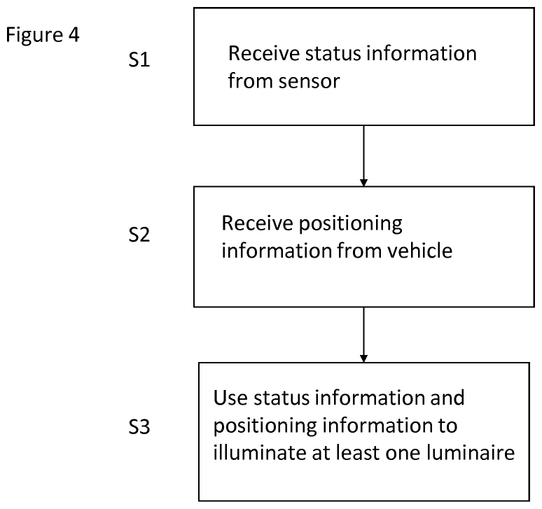

A flowchart of a method according to an embodiment is shown at FIG. 4. This method is viewed from a perspective of a controller controlling the lighting system. As shown at step S1 a controller receives status information from at least one sensor. The information comprises status information of at least one container in an environment in which the at least one container is located.

Then, at step S2 the controller receives positioning information from a vehicle in the environment.

At step S3 the controller uses the status information of the at least one container and the positioning information of the vehicle to cause the at least one luminaire to be illuminated in a fashion that guides a driver of the vehicle relative to the at least one container.

Accordingly, a driver of the vehicle can be efficiently directed to the container(s) to be emptied.

Of course, this method may also comprise the further steps or features described above with respect to the controller and/or system.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A controller for controlling a lighting system so as to guide a vehicle, comprising:
an interface arranged for communicating with at least one luminaire for illuminating an environment in which at least one container is located, the interface further arranged to communicate with at least one sensor for monitoring usage of the at least one container;
the controller arranged to receive and process information of the at least one container from the at least one sensor, so as to obtain status information of the at least one container; and
the controller arranged to receive positioning information from a vehicle in the environment;
the controller arranged to use the status information of the at least one container and the positioning information of the vehicle to cause the at least one luminaire to illuminate an environment in which the at least one container is located such as to provide guidance to a driver of the vehicle relative to the at least one container.

2. A controller as set forth in claim 1, the at least one container comprising at least one garbage container.

3. A controller as set forth in claim 1, the vehicle comprising a garbage truck.

4. A controller as set forth in claim 1, the status information comprising a fill-level of the at least one container.

5. A controller as set forth in claim 1, the status information comprising information of walking patterns of people.

6. A controller as set forth in claim 1, the at least one sensor comprising any combination of: one or more cameras; one or more microphones; one or more infra-red cameras; one or more external data sources of external usage.

7. A controller as set forth in claim 1, the at least one sensor attached to the at least one container.

8. A controller as set forth in claim 1, wherein the at least one sensor monitors the at least one container remotely.

9. A controller as set forth in claim 1, the controller arranged to cause the at least one luminaire to be illuminated indicating a direction to guide the driver of the vehicle to the at least one container.

10. A controller as set forth in claim 1, the controller configured to cause the at least one luminaire to illuminate the at least one container with an intensity dependent on its need for emptying.

11. A controller as set forth in claim 1, the controller arranged to cause the illumination of the at least one luminaire dependent upon a detected distance of the vehicle from the at least one luminaire.

12. A controller as set forth in claim 1, the controller arranged to cause the at least one luminaire to illuminate so as to provide guidance to the at least one container only when the vehicle is within a predetermined proximity of the at least one container.

13. A controller as set forth in claim 1, the controller further configured to calculate a route which minimizes resource usage of the vehicle and/or driver, the controller configured to illuminate the at least one luminaire in accordance with the calculated route.

14. A method of guiding a vehicle comprising:
receiving information from at least one sensor, the information comprising status information of at least one container in an environment in which the at least one container is located;
receiving positioning information from a vehicle in the environment; and
using the status information of the at least one container and the positioning information of the vehicle to cause the at least one luminaire to illuminate an environment in which the at least one container is located such as to provide guidance to a driver of the vehicle relative to the at least one container.

15. A computer program product comprising computer-executable code embodied on a non-transitory storage medium arranged so as when executed on one or more processing units to carry out the method steps according to claim 14.
